(19) United States
(12) Patent Application Publication
(10) Pub. No.: US 2019/0311073 A1
(43) Pub. Date: Oct. 10, 2019

(54) METHOD AND SYSTEM FOR EXCHANGING DATA BETWEEN DIFFERENT SUB SYSTEMS

(71) Applicant: Enterprixe Software Ltd AB, Helsinki (FI)

(72) Inventor: Simo RUOKAMO, Oulu (FI)

(73) Assignee: Exterprixe Software Ltd AB, Helsinki (FI)

(21) Appl. No.: 16/340,173

(22) PCT Filed: Oct. 5, 2017
(86) PCT No.: PCT/EP2017/075351

§ 371 Date: Apr. 8, 2019

(30) Foreign Application Priority Data
Oct. 14, 2016 (FI) 20165787

(51) Int. Cl. G06F 17/50; G06F 16/28; G06F 16/22

(52) U.S. Cl. CPC G06F 17/5004; G06F 16/2246; G06F 16/282

(57) ABSTRACT

A method for exchanging data between different sub systems, the data relating to one or more buildings, is disclosed. The method comprises the following steps taken in any order: creating one or more applications for each different sub system; collecting the data in a single remotely stored and common shared Building Information Model, BIM, database via the one or more applications, and storing the data in the BIM database without conversion of the data; and providing the different sub systems access to the BIM database via the one or more applications, the access to the data being simultaneous for the different sub systems by allowing each different sub system to read any data in the BIM database at any time and by allowing each different sub system to reserve and release data in the BIM database for changing data in the BIM database. A system providing different sub systems with data exchange, according to such a method, to a database is also disclosed, the data relating to one or more buildings. The system comprises the database being a BIM database, the BIM database being a single remotely stored and common shared BIM database, data stored without conversion of the data in the BIM database. The BIM database comprises a single root class from which all other data model classes of each different sub system are derived, configured as a single and scalable data structure for the entire data model of the BIM database and all data operations on the BIM database, the single root class defining and handling all data of all objects in the data model, and the BIM database comprising a hierarchical tree structure where the hierarchical tree structure is configured according to parts and/or properties of the one or more physical buildings. The system comprises an application for each different sub system, the application being configured with one or more user accounts configured to access the data in the BIM database, and the application configured to share the BIM database via the one or more applications. The system comprises an access between the BIM database and each different sub system to allow data transfer between the BIM database and each different sub system via the application for each different sub system, the access comprising configuring the application to allow each different sub system to read any data in the BIM database simultaneously at any time and configuring the application to allow each different sub system to reserve and release data in the BIM database for changing data in the BIM database.

### TECHNICAL FIELD

The present disclosure relates to data exchange between different sub systems. More particularly, the present disclosure relates to a method for exchanging data between different sub systems, the data relating to one or more buildings. More particularly, the present disclosure relates to a system providing different sub systems with data exchange, for such a method, to a database, the data relating to one or more buildings. The data exchange is a sharing of the data without conversion of the data.

### BACKGROUND

A life cycle of a building includes a large amount of information. The information starts for example with information about the owner of the land, information from the project managers, information relating to the authorities, etc. The information may continue with information from the architect, structural engineer, mechanical and electrical engineer, etc. Further information may come from prefabrication, contractors, and suppliers. The information flow continues when the building is ready with, for example, information from a facility manager, leaseholders, demolition, etc. In recent years, much effort has been invested in collecting, storing, and providing such information to all parties that need and would like such information.

The information created by such parties is stored by each party. To share the information the existing solution is to use the Industry Foundation Classes, IFC, data model. The IFC data model is intended to describe building and construction industry data and is used for sharing such information in a distributed way. This distributed way is illustrated by FIG. 1, where reference numbers 1-5 are five exemplary different parties sharing information. For example, if a contractor 3 needs information from the architect 1, then such information is converted by the architect's system according to IFC and sent to the contractor 3. The contractor 3 then converts the information to the system the contractor is using. Using IFC is the industry standard and using IFC works. However, it is desirable to improve this kind of exchange of information and use of IFC. Furthermore, large and influential corporations on this market provide flat file solutions.

It is desirable to provide a method and system for sharing and using information relating to a building. This must be done in view of the building industry and related parties. A solution must be cost effective and realistic in real life. A solution must also be something that is acceptable in the present industry. The present disclosure is directed to overcoming one or more of the problems as set forth above.

### SUMMARY OF THE INVENTION

It is an object of the present invention to provide a method for exchanging data between different sub systems, the data relating to one or more buildings, and to provide a system providing different sub systems with data exchange, according to such a method, to a database, the data relating to one or more buildings. This object can be achieved by the features as defined by the independent claim. Further enhancements are characterised by the dependent claims.

According to one embodiment, a method for exchanging data between different sub systems, the data relating to one or more buildings, is disclosed. The method comprises the following steps taken in any order: creating one or more applications for each different sub system; collecting the data in a single remotely stored and common shared Building Information Model, BIM, database via the one or more applications, and storing the data in the BIM database without conversion of the data; and providing the different sub systems access to the BIM database via the one or more applications, the access to the data being simultaneous for the different sub systems by allowing each different sub system to read any data in the BIM database at any time and by allowing each different sub system to reserve and release data in the BIM database for changing data in the BIM database.

According to one embodiment, collecting the data in the BIM database is made by configuring the BIM database as a hierarchical tree structure, and the hierarchical tree structure is configured according to parts and/or properties of the one or more physical buildings. The parts and/or properties may be location, functionality, type and other properties of parts. The hierarchical tree structure may be configured to comprise partial models of the BIM database.

According to one embodiment, collecting the data in the BIM database is made using a single root class from which all other data model classes of each different sub system are derived, providing a single and scalable data structure for the entire data model of the BIM database and all data operations on the BIM database, the single root class defining and handling all data of all objects in the data model.

According to one embodiment, each different sub system comprises one or more user accounts, the one or more user accounts being accessible via the one or more applications, and the one or more user accounts enabling a user to reserve and release edit rights of the data in the BIM database based on hierarchical sub-trees.

According to one embodiment, saving the data in the BIM database is made with no redundancy by saving the data in the BIM database only once. According to one embodiment, data in the BIM database is linked according to physical properties of parts of the one or more buildings in addition to the hierarchical tree structure. The link may be a relation between two nodes and the link may comprise functionality. According to one embodiment, the BIM database is provided as a cloud server.

According to one embodiment, a system providing different sub systems with data exchange, according to any one of the preceding embodiments, to a database is disclosed, the data relating to one or more buildings. The system comprises the database being a Building Information Model, BIM, database, the BIM database being a single remotely stored and common shared BIM database, data stored without conversion of the data in the BIM database, the BIM database comprising a single root class from which all other data model classes of each different sub system are derived, configured as a single and scalable data structure for the entire data model of the BIM database and all data operations on the BIM database, the single root class defining and handling all data of all objects in the data model, and the BIM database comprising a hierarchical tree structure where the hierarchical tree structure is configured according to parts and/or properties of the one or more physical buildings. The parts and/or properties may be location, functionality, type and other properties of parts. The hierarchical tree structure may comprise partial models of the BIM database. The system comprises an application for each different sub system, the application being configured with one or more user accounts configured to access the data in the BIM database, and the application configured to share the BIM database via the one or more applications. The system comprises an access between the BIM database and each different sub system to allow data transfer between the BIM database and each different sub system via the application for each different sub system, the access comprising configuring the application to allow each different sub system to read any data in the BIM database simultaneously at any time and configuring the application to allow each different sub system to reserve and release data in the BIM database for changing data in the BIM database.

According to one embodiment, the one or more user accounts are configured to be accessible via the one or more applications, the one or more user accounts enabling a user to reserve and release edit rights of the data in the BIM database based on hierarchical sub-trees.

According to one embodiment, the BIM database only saves the data in the BIM database once, with no redundancy. According to one embodiment, the BIM database is configured to link the data in the BIM database according to physical properties of parts of the building in addition to the hierarchical tree structure. The link may be a relation between two nodes and the link may comprise functionality. According to one embodiment, the BIM database is a cloud server.

According to at least one embodiment, a database is used instead of flat files. The use of a database enables sharing the data with a real multiuser capability, integration by having no redundant or converted data, integrity by no self-conflicts, security with access right management, abstract by the forward and backward capability to add new data, and independency because the BIM database and the applications are separate. Furthermore, the use of a hierarchical organization and/or structure of the data model for the BIM database allows a user or an application to reserve a part of the model, a partial model of the BIM database. In this way a part of the model can be handled. This makes is possible to handle a large amount of data, and a BIM database can become very large, especially if the BIM database relates to several buildings. This partial handling allows a user or an application to handle a part of the BIM database, instead of having to work on the whole data collection. It also allows giving partial access to a user. When reference is made herein to scalability, there are two aspects of the scalability. The first aspect is performance of the memory. The size of the BIM database can be scaled up or down according to storage needed for the building information model. The second aspect is scalability of functionality by an application. Any application can be added without having to change the core system. An old, present, or future system can thus be integrated into the method and system described herein by an application made for the old, present, or future system. This allows forward and backward compatibility. A software development kit, SDK, is provided to create such an application for the method and system described herein.

According to one embodiment, a computer program product comprises computer logic configured to perform all the steps, or one or more of the steps, of the method disclosed herein, when said program is run and/or executed on a computer and/or processing means.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment or embodiments.

### BRIEF DESCRIPTION OF THE DRAWINGS

The accompanying drawings illustrate presently exemplary embodiments of the disclosure, and together with the general description given above and the detailed description of the embodiments given below, serve to explain, by way of example, the principles of the disclosure.

FIG. 1 shows a diagrammatic illustration of prior art using IFC;

FIG. 2 shows a diagrammatic illustration of an exemplary embodiment of the present disclosure;

FIG. 3 shows a diagrammatic illustration of an exemplary embodiment of a method of the present disclosure; and

FIG. 4 shows a diagrammatic illustration of an exemplary embodiment of the present disclosure.

### DETAILED DESCRIPTION

The building industry is a fragmented industry and it is difficult to provide solutions that can be used and appeal to the whole, or at least a major part, of the building industry. Each party/operator has an own agenda and issues that are more or less important. In recent years attention has been given to the building industry not increasing their productivity as much as other industries have. Only market demand will not lead to a productivity increase, and technology push with the described method and system herein may complement to achieve a productivity increase. In view of how to provide parties with data of a building, FIG. 2 illustrates an exemplary embodiment of the disclosed method and system. Parties 1 to 5 share a single and common remotely stored database 10. Instead of sending data according to IFC between parties, the data is stored once and without conversion in the database 10 and each party can access the data simultaneously. The database 10 is a Building Information Model, BIM, database 10. A BIM may be a digital representation of physical and functional characteristics of a facility. A BIM may be information about, one or more of, a facility, a building, forming a basis for decisions during its life-cycle; defined as existing from earliest conception to demolition. Building information modelling data may comprise the three primary spatial dimensions with further features, such as for example, time, costs, spatial relationships, light analysis, geographic information, quantities, and properties of building components (for example, manufacturers' details). BIM data may involve representing a design as combinations of objects, for example in a vague and undefined form, generic or product-specific, solid shapes or void-space oriented (like the shape of a room), that carry their geometry, relations and attributes. The data may for example carry attributes for selecting and ordering them, providing cost estimates, etc. BIM data may be created by one or more parties 1 to 5. In other words, the data in the BIM database 10 relates to one or more buildings, for example the parts and/or properties of the one or more physical buildings. The BIM database 10 is a database, and the database is defined as not, at least, a flat file or a combination of flat files.

For this disclosure and with reference to FIG. 4, each exemplary party is a sub system 21, 22, 23, that may have its own software application for creating and handling BIM data, such as for example a sub system for an architect or one for a contractor, or an engineer, or facility manager, etc. Each sub system 21, 22, 23 has at least one application 24, 25, 26. Each sub system 21, 22, 23 may have a local database 27, 28, 29. The local database may be kept up to date by loading only changes form the BIM database 10. Changes to reserved parts may be made first to a local database and when released, such changes may be uploaded to the BIM database 10 and made available for other users. A change and reservation log, preferably at the BIM database, may enable this. The application 24, 25, 26 allows the respective subsystem 21, 22, 23 to access the BIM database 10. The exemplary embodiment illustrated by FIG. 4 is further explained below.

To realize the herein disclosed system and method and using of a single remotely stored and common shared BIM database 10, the following may be done and configured. The application 24, 25, 26 uses the same and shared data model instead of their native and separate models of the sub system. All information is saved only once in the BIM database without requiring or making data conversions. The single shared BIM database 10 allows this. The data exchange between the parties 1-5 is a sharing of the data without conversion of the data. Furthermore, a software development kit, SDK, for the data modelling may be provided. The SDK may implement model dividing into independent partial models that can be edited separately. The use of a hierarchical organization and arrangement of the data model allows this. User accounts may be provided to allow reserving and releasing edit rights for independent partial models to prevent data conflicts and redundancies. The use of a hierarchical organization and arrangement of the data model and user accounts allows this. The hierarchical tree structure may comprise partial models of the BIM database. The reserving and releasing of edit rights of the partial model may be realised by defined hierarchical sub trees. The data model used allows free additions of new content and data types without disrupting the compatibility of the data model. All data model classes may be derived from a single data model root class provided by the SDK, defining the only data structure for the whole data model and implements all data operations. The data model root class may define all attributes as collection of name and value pairs. There may be different collections for basic data types, such as whole numbers, floating point numbers, truth-value, two dimensional vectors and points, three dimensional vectors and points, and linked part identifiers. The data model root class may be saved as a XML to the BIM database and vice versa. Derived classes may add new name-value attribute pairs into collections and the root class may handle all saving and reading with the BIM database. A permanent storage for the data model may be a single shared database, preferably located in the cloud, that all applications can access concurrently. For example, a web service with an adequate functionality for accessing the single shared data model and database may be suitable for this.

According to one embodiment, the web service may implement the following functionalities. Registration of users for getting valid credentials and access to the shared model. Login and connect to model with valid user credentials. Load for getting the whole model or a desired partial model available for a client sub system and/or application. This may be saved to a local database in case no new load is needed between separate connections to a model. After load model data may be read but not changed. Reserve for reserving a desired partial model for editing. Changes during reservation are made to a local database. If a client database provided by a SDK is not used by sub system and/or application, then changes may be released before ending application or stored in another way provided by the sub system. Release for releasing a reserved partial model. Changes made locally are uploaded to the BIM database and may be made available for other users having access to the model. Get changes for getting changes caused by releases made by other users. Logout for ending a connection to a model. This list of functions are examples of base functionalities. In an implementation the number of actual functions is larger, but they still implement the same basic functionality.

Turning to the data model and BIM database, the data model is a collection of classes. The data model holds all the model information on the classes. Reading and saving data is handled by the data model root class provided by the SDK. The SDK may also include a set of generic and non-application specific classes that are all derivable from the data model root class. The application for each sub system extends and scales the data model for the need of the sub system by defining new classes with derivation from existing classes. Sub systems are not allowed to make changes at a database level. New classes may, for example, be defined from existing classes by derivation. A derived class may inherit all the functionality and attributes from the parent class. The derivation path of all the data model classes may start from the data model root class so that they may inherit the data handling tools with the database that are defined in data model root class. According to at least one embodiment, a software class may be code written by a programmer. A class created into a memory of an application is an instance or an object. Multiple instances may be created from the same code. Creating a class is creating an instance or an object from the code that represents a class.

According to at least one embodiment, every row in the database may have its own globally unique identifier. Each row in the BIM database may represents one instance of class in the data model with the same global unique identifier. Data in a row may be read from the BIM database and the corresponding data model class instance may be created into the data model and running memory of an application. Each database row may store the information about which class must be created or instantiated into the running memory (random access memory RAM) of an application for that row. The database may contain the following. A globally unique identifier. A globally unique identifier of a parent, which makes up the hierarchical arrangement. Definition of a class, which may be instantiated from a database row. Definition of a SDK generic class. In case an exact class cannot be instantiated, then the nearest SDK class may be instantiated instead. A name of a node and/or part. Data as XML, all data of a part may for example be presented in the eXtensible Markup Language format.

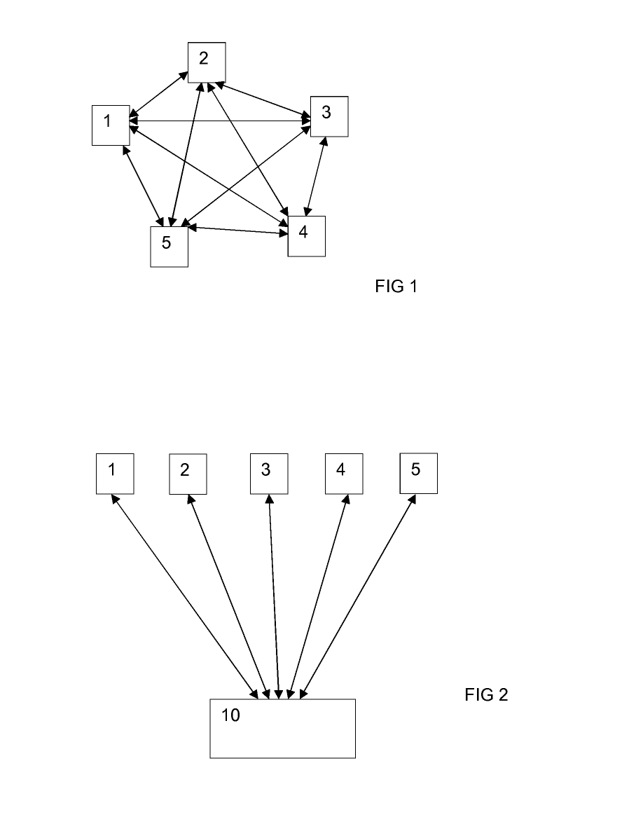

Turning to FIGS. 1 and 2 again, it is a problem how to provide each party 1 to 5 with data relating to one or more buildings. The solution illustrated in FIG. 2 collects the data in a building information model database 10 and provides parties 1 to 5 access to the BIM data via applications for each party according to their need and/or program. The data relates to one or more buildings and is collected in a single remotely stored and common shared BIM database, without conversion of the data.

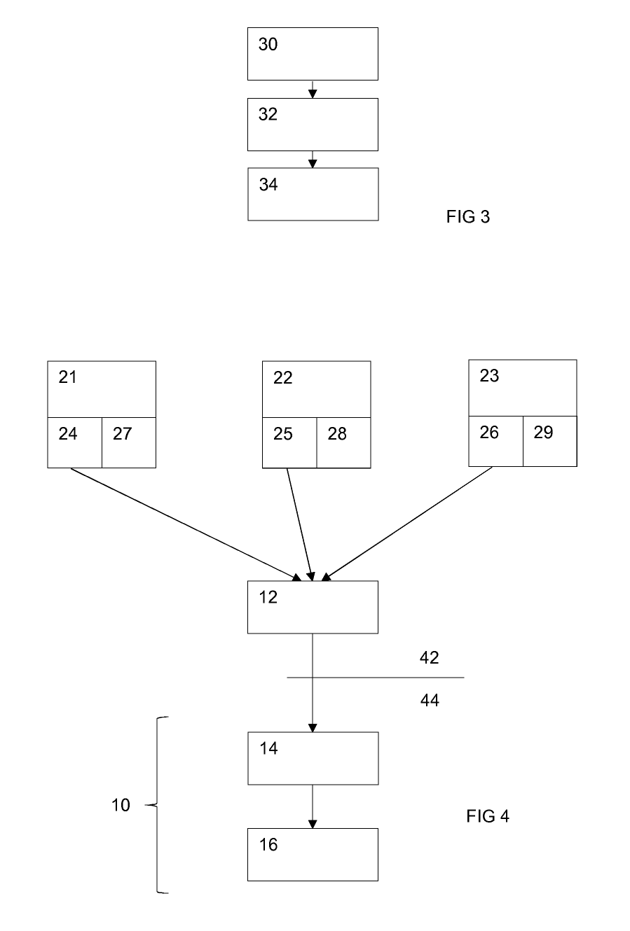

FIG. 3 shows a diagrammatic illustration of an exemplary embodiment of a method according to the present disclosure. The method is for exchanging data between different sub systems 21, 22, 23, for example parties 1 to 5. The data exchange between the sub systems 21, 22, 23 is a sharing of the data without conversion of the data. The data relates to one or more buildings. The method comprises the following steps taken in any order. Step 30, creating one or more applications 24, 25, 26 for each different sub system 21, 22, 23. Step 32, collecting the data in a single remotely stored and common shared Building Information Model, BIM, database 10 via the one or more applications 24, 25, 26, and storing the data in the BIM database 10 without conversion of the data. Step 34, providing the different sub systems 21, 22, 23 access to the BIM database 10 via the one or more applications 24, 25, 26. The access to the data being simultaneous for the different sub systems 21, 22, 23 by allowing each different sub system 21, 22, 23 to read any data in the BIM database 10 at any time and by allowing each different sub system 21, 22, 23 to reserve and release data in the BIM database for changing data in the BIM database. The BIM database is not a flat file or a combination of flat files.

According to one embodiment, collecting the data in the BIM database 10 is made by configuring the BIM database 10 as a hierarchical tree structure, and the hierarchical tree structure is configured according to parts and/or properties of the one or more physical buildings. Structuring the data as a hierarchical tree structure according to parts and properties of a building allows handling the data in question and allows shared use and separate editing. The hierarchical structure may be configured by a user of the sub system. It may for example be based on horizontal or vertical positions of building parts, type of parts, design, properties, disciplines, sectors, etc. In addition to a freely defined hierarchy there is a forced hierarchy defined by the sub systems. For example, a reinforcement bar usually does not exist alone but is inside some part made of concrete, and a door handle is normally a part of a door or similar and must lie below the door in the hierarchy. The use of a hierarchical organization and/or structure of the data model for the BIM database allows a user or an application to reserve a part of the model, a partial model of the BIM database. The hierarchical tree structure may thus be configured to comprise partial models of the BIM database. In this way a part of the model can be handled instead of the whole. This makes is possible to handle a large amount of data, and a BIM database can become very large, especially if the BIM database relates to several buildings. This partial handling allows a user or an application to handle a part of the BIM database, instead of having to work on the whole data collection, which can be very large. It also allows giving partial access to a user.

According to one embodiment, collecting the data in the BIM database 10 is made using a single root class from which all other data model classes of each different sub system are derived, providing a single and scalable data structure for an entire data model of the BIM database and all data operations on the BIM database, the single root class defining and handling all data of all objects in the data model. This scalable data structure allows the data model and BIM database to be fully compatible forwards and backwards, for example adding data. Every sub system may connect and handle databases and models whose data is older or newer, for example new data added by other sub systems, without any data conversion. There may be two aspects of the scalability. The first aspect is performance of the memory. The size of the BIM database can be scaled up or down according to storage needed for the building information model. The second aspect is scalability of functionality by an application. Any application can be added without having to change the core system. An old, present, or future system can thus be integrated into the method and system described herein by an application made for the old, present, or future system. This allows forward and backward compatibility. The SDK is provided to create such an application for the method and system described herein.

According to one embodiment, each different sub system comprises one or more user accounts. The one or more user accounts being accessible via the one or more applications 24, 25, 26, and the one or more user accounts enabling a user to reserve and release edit rights of the data in the BIM database 10 based on hierarchical sub-trees.

According to one embodiment, saving the data in the BIM database 10 is made with no redundancy by saving the data in the BIM database only once. Such a saving is thus done in only one physical location. The saving is done with no conversion of the data. Such a conversion is necessary when IFC is used.

According to one embodiment, data in the BIM database is linked according to physical properties of parts of the one or more buildings in addition to the hierarchical tree structure. This allows a further way of accessing the data in the BIM database. A link is an address between the parts in the hierarchy, for example a globally unique identifier contained in every node or part of the hierarchy. The link is one or two ways. The link may include a functionality that may have been defined by the sub system that has developed it. An example of functionality may be to read all or some data from the linked node. A connection between two parts, data, is also an exemplary link whose function may be to define how connected parts are modified. For example, a link between two wooden parts may define how they are sawn.

According to one embodiment, the BIM database is provided as a cloud server. This allows a user of the sub system to access the BIM database conveniently through web service functions.

FIG. 4 is a diagrammatic illustration of an exemplary embodiment of a system according to the present disclosure. The system provides different sub systems 21, 22, 23 with data exchange, according to any one of the embodiments described herein, to a database, the data relating to one or more buildings. In this way data can be exchanged between the sub systems 21, 22, 23. The data exchange between the sub systems 21, 22, 23 is a sharing of the data without conversion of the data. The database is a Building Information Model, BIM, database 10. The BIM database comprises the BIM model 14 and the BIM database 16. The BIM database comprises a single root class from which all other data model classes of each different sub system 21, 22, 23 are derived, configured as a single and scalable data structure for the entire data model of the BIM database and all data operations on the BIM database 10. There may be two aspects of the scalability. The first aspect may be performance of the memory. The size of the BIM database can be scaled up or down according to storage needed for the building information model. The second aspect may be scalability of functionality by an application. Any application can be added without having to change the core system. An old, present, or future system can thus be integrated into the method and system described herein by an application made for the old, present, or future system. This allows forward and backward compatibility. The single root class defining and handling all data of all objects in the building data model 14. The BIM database 10 comprises a hierarchical tree structure where the hierarchical tree structure is configured according to parts and/or properties of the one or more physical buildings. The use of a hierarchical organization and/or structure of the data model for the BIM database allows a user or an application to reserve a part of the model, a partial model of the BIM database. In this way a part of the model can be handled. This makes it possible to handle a large amount of data, and a BIM database can become very large, especially if the BIM database relates to several buildings. This partial handling allows a user or an application to handle a part of the BIM database, instead of having to work on the whole data collection. It also allows giving partial access to a user. The system comprises an application 24, 25, 26 for each different sub system 21, 22, 23, the application 24, 25, 26 being configured with one or more user accounts configured to access the data in the BIM database 10. The system comprises an access between the BIM database 10 and each different sub system to allow data transfer between the BIM database 10 and each different sub system 21, 22, 23 via the application 24, 25, 26 for each different sub system 21, 22, 23. The access comprising configuring each application 24, 25, 26 to allow each different sub system 21, 22, 23 to read any data in the BIM database 10 simultaneously at any time and configuring the application 24, 25, 26 to allow each different sub 21, 22, 23 system to reserve and release data in the BIM database 10 for changing data in the BIM database 10.

The BIM database is not a flat file or a combination of flat files. Collecting the data in the BIM database 10 may be made using a single root class functionality from which all other data model classes of each different sub system are derived, providing a single and scalable data structure for an entire data model of the BIM database and all data operations on the BIM database, the single root class defining and handling all data of all objects in the data model. This scalable data structure allows the data model and BIM database to be fully compatible forwards and backwards, for example adding data. Each sub system may connect and handle databases and models whose data is older or newer, for example new data added by other sub systems, without any data conversion. All data is defined by data model root class as name-value pair collections and collections are mapped as single XML data into the database. Only the number of items in collections can vary, the database schema is constant. This implements the backward and forward compatibility of the data model and the database.

According to one embodiment, the BIM database 10 may comprise a common data model section 14 for all applications 24, 25, 26. The common data model section 14 may store the data in one or more permanent shared storage databases 16.

According to one embodiment, the system in FIG. 4 comprises a server side 44 and a client, user, side 42. The BIM database 10 is located on the server side 44. A web service 12 may be located on the client side 42 and may be the connection route between the client side and the server side. The sub systems 21, 22, 23 and their respective applications 24, 25, 26 are located on the client side 42. Each sub system 21, 22, 23 may have a local database 27, 28, 29, which may store a local copy of the database in a desired extent and/or store changes for reserved parts.

According to one embodiment, the one or more user accounts are configured to be accessible via the one or more applications 24, 25, 26. The one or more user accounts enabling a user to reserve and release edit rights of the data in the BIM database 10 based on hierarchical sub-trees.

According to one embodiment, the BIM database 10 only saves the data in the BIM database 10 once, with no redundancy. The BIM database 10 may be configured to only save data in one physical location within the BIM database. The saving is done with no conversion of the data.

According to one embodiment, the BIM database 10 is configured to link the data in the BIM database according to physical properties of parts of the building in addition to the hierarchical tree structure. This allows a further way of accessing the data in the BIM database.

According to one embodiment, the BIM database 10 is a cloud server. This allows a user of the sub systems 21, 22, 23 to conveniently access the BIM database 10, for example over the internet cloud with the help of web service functions.

It will be apparent to those skilled in the art that various modifications and variations can be made to the method and system. Other embodiments will be apparent to those skilled in the art from consideration of the specification and practice of the disclosed method and system. It is intended that the specification and examples be considered as exemplary only, with a true scope being indicated by the following claims and their equivalents.

1. A method for exchanging data between different sub systems, the data relating to one or more buildings, the method comprising the following steps taken in any order:
creating one or more applications for each different sub system;
collecting the data in a single remotely stored and common shared Building Information Model, BIM, database via the one or more applications, and storing the data in the BIM database without conversion of the data; and
providing the different sub systems access to the BIM database via the one or more applications, the access to the data being simultaneous for the different sub systems by allowing each different sub system to read any data in the BIM database at any time and by allowing each different sub system to reserve and release data in the BIM database for changing data in the BIM database.

2. The method of claim 1, wherein collecting the data in the BIM database is made by configuring the BIM database as a hierarchical tree structure, and the hierarchical tree structure is configured according to parts and/or properties of the one or more physical buildings, and the hierarchical tree structure is configured to comprise partial models of the BIM database.

3. The method of claim 1, wherein collecting the data in the BIM database is made using a single root class from which all other data model classes of each different sub system are derived, providing a single and scalable data structure for the entire data model of the BIM database and all data operations on the BIM database, the single root class defining and handling all data of all objects in the data model.

4. The method according to claim 1, wherein each different sub system comprises one or more user accounts, the one or more user accounts being accessible via the one or more applications, and the one or more user accounts enabling a user to reserve and release edit rights of the data in the BIM database based on hierarchical sub-trees.

5. The method according to claim 1, wherein saving the data in the BIM database is made with no redundancy by saving the data in the BIM database only once.

6. The method according to claim 1, wherein data in the BIM database is linked according to physical properties of parts of the one or more buildings in addition to the hierarchical tree structure.

7. The method according to claim 1, wherein the BIM database is provided as a cloud server.

8. A system providing different sub systems with data exchange, according to claim 1, to a database, the data relating to one or more buildings, the system comprising:
the database being a Building Information Model, BIM, database, the BIM database being a single remotely stored and common shared BIM database, data stored without conversion of the data in the BIM database, the BIM database comprising a single root class from which all other data model classes of each different sub system are derived, configured as a single and scalable data structure for the entire data model of the BIM database and all data operations on the BIM database, the single root class defining and handling all data of all objects in the data model, and the BIM database comprising a hierarchical tree structure where the hierarchical tree structure is configured according to parts and/or properties of the one or more physical buildings and the hierarchical tree structure comprising partial models of the BIM database;
an application for each different sub system, the application being configured with one or more user accounts configured to access the data in the BIM database, and the application configured to share the BIM database via the one or more applications; and
an access between the BIM database and each different sub system to allow data transfer between the BIM database and each different sub system via the application for each different sub system, the access comprising configuring the application to allow each different sub system to read any data in the BIM database simultaneously at any time and configuring the application to allow each different sub system to reserve and release data in the BIM database for changing data in the BIM database.

9. The system according to claim 10, wherein the one or more user accounts are configured to be accessible via the one or more applications, the one or more user accounts enabling a user to reserve and release edit rights of the data in the BIM database based on hierarchical sub-trees.

10. The system according to claim 8, wherein the BIM database only saves the data in the BIM database once, with no redundancy.

11. The system according to claim 8, wherein the BIM database is configured to link the data in the BIM database according to physical properties of parts of the building in addition to the hierarchical tree structure.

12. The system of claim 8, wherein the BIM database is a cloud server.

13. A computer program product comprising a computer-usable medium having computer-readable program code embodied therein, the computer-readable program code configured to be executed to perform the steps of the method of claim 1.
